(19) United States
(12) Patent Application Publication
(10) Pub. No.: US 2023/0306455 A1
(43) Pub. Date: Sep. 28, 2023

(54) INFORMATION PROCESSING APPARATUS, INFORMATION PROCESSING SYSTEM, AND PROGRAM

(71) Applicant: SEIKO EPSON CORPORATION, Tokyo (JP)

(72) Inventor: Naoya SATO, Tomi-shi (JP)

(73) Assignee: SEIKO EPSON CORPORATION, Tokyo (JP)

(21) Appl. No.: 18/187,659

(22) Filed: Mar. 21, 2023

(30) Foreign Application Priority Data
Mar. 24, 2022 (JP) 2022-047979

(51) Int. Cl. G06Q 30/0207; G01B 21/30

(52) U.S. Cl. CPC G06Q 30/0207; G01B 21/30

(57) ABSTRACT

An information processing apparatus generates road surface type information based on data detected by an electronic device provided to move together with a foot of a user, the road surface type information indicating a type of road surface on which the user has moved, and outputs evaluation information based on the generated road surface type information, the evaluation information indicating an evaluation of the user.

The present application is based on, and claims priority from JP Application Serial Number 2022-047979, filed Mar. 24, 2022, the disclosure of which is hereby incorporated by reference herein in its entirety.

### BACKGROUND

### 1. Technical Field

This disclosure relates to an information processing apparatus, an information processing system, and a program.

### 2. Related Art

Technologies for supporting people's lives have been researched and developed.

In this regard, there is known an information processing system in which the reward to be paid to a delivery worker is determined based on the distance the worker traveled for delivery, the number of packages, weather, and the like (see JP-A-2020-003863).

However, the information processing system described in JP-A-2020-003863 does not have a configuration for detecting the slope, steps, or the like of the road surface over which a delivery worker passes at the times of delivery. As a result, the information processing system may be unable to determine a reward appropriate for the burden of movement for the delivery worker.

### SUMMARY

An aspect of this disclosure for solving the above-described problem is an information processing apparatus configured to generate road surface type information based on data detected by an electronic device provided to move together with a foot of a user, the road surface type information indicating a type of road surface on which the user moved, and output evaluation information based on the generated road surface type information, the evaluation information indicating an evaluation of the user.

In addition, an aspect of this disclosure is an information processing system including the information processing apparatus described above and the electronic device described above.

In addition, an aspect of this disclosure is a non-transitory computer-readable storage medium storing a program, the program being configured to cause a computer of an information processing apparatus to generate road surface type information based on data detected by an electronic device provided to move together with a foot of a user, the road surface type information indicating a type of road surface on which the user moved, and output evaluation information based on the generated road surface type information, the evaluation information indicating an evaluation of the user.

### BRIEF DESCRIPTION OF THE DRAWINGS

FIG. 1 is a diagram illustrating an example of a configuration of an information processing system 1.

FIG. 2 is a diagram illustrating an example of a hardware configuration of an electronic device 10.

FIG. 3 is a diagram illustrating an example of a hardware configuration of an information processing apparatus 20.

FIG. 4 is a diagram illustrating an example of a hardware configuration of a mobile terminal 30.

FIG. 5 is a diagram illustrating an example of functional configurations of the electronic device 10 and the information processing apparatus 20.

FIG. 6 is a flowchart illustrating an example of the flow of processing of the information processing apparatus 20 to acquire detection data from the electronic device 10.

FIG. 7 is a flowchart illustrating an example of the flow of processing of the information processing apparatus 20 to output evaluation information indicating an evaluation of a user U.

FIG. 8 is a flowchart illustrating an example of the flow of processing of the information processing apparatus 20 to determine whether a movement method of the user U is different from the prior application.

### DESCRIPTION OF EXEMPLARY EMBODIMENTS

### Embodiments

Exemplary embodiments of this disclosure will be described below with reference to the drawings.

Overview of Information Processing System

First, an overview of an information processing system according to an embodiment will be described.

The information processing system according to an embodiment includes an electronic device and an information processing apparatus. The electronic device is provided to move with a foot of a user. The information processing apparatus generates road surface type information indicating the type of the road surface on which the user has moved based on the data detected by the electronic device, and outputs evaluation information indicating an evaluation of the user based on the generated road surface type information. Thus, the information processing system can provide the user with the evaluation appropriate for the burden of the movement for the user.

A configuration of the information processing system and processing of the information processing system according to an embodiment will be described in detail below.

Configuration of Information Processing System

Hereinafter, a configuration of the information processing system according to an embodiment will be described exemplifying an information processing system 1.

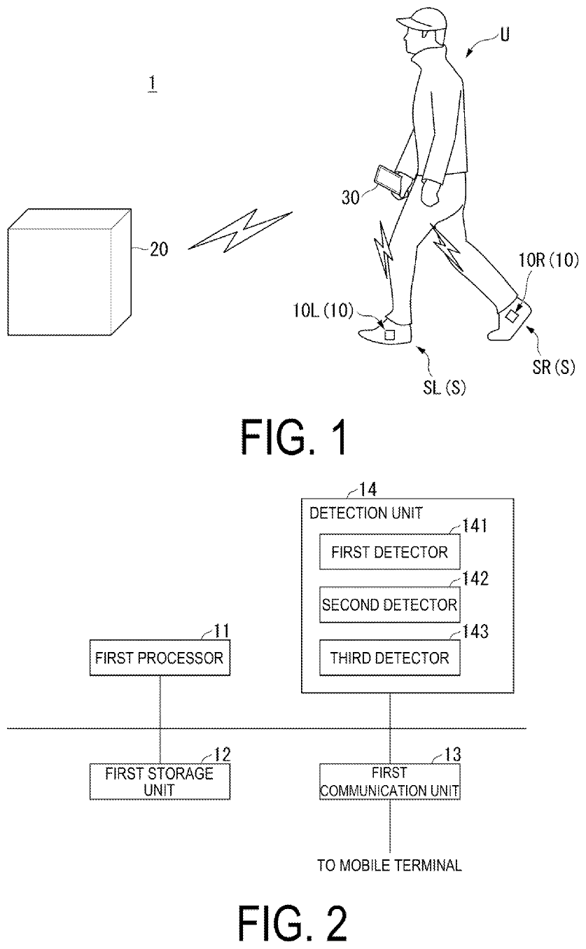

FIG. 1 is a diagram illustrating an example of a configuration of the information processing system 1. As an example, a case in which a user of the information processing system 1 is a user U illustrated in FIG. 1 will be described below.

The information processing system 1 is a system used when the user U is caused to perform a predetermined action. The predetermined action is an action that involves movement of the user U resulting from his or her bipedal locomotion. For example, the predetermined action may be a task that involves movement of the user U resulting from his or her bipedal locomotion such as food or beverage delivery work, courier delivery work, moving work, and newspaper delivery work, exercise that involves movement of the user U resulting from his or her bipedal locomotion such as walking, speed walking, and running, or another type of action that involves movement of the user U resulting from his or her bipedal locomotion. Here, in the present embodiment, movement of the user U by bipedal locomotion may mean walking, running, or a combination of walking and running. The information processing system 1 outputs evaluation information indicating an evaluation on a burden of movement of the user U by bipedal locomotion in such a predetermined action. A period in which the user U performs the predetermined action will be referred to as a “measurement period” below for the sake of convenience of description. In addition, hereinafter, for the sake of convenience of description, movement of the user U by bipedal locomotion will be simply referred to as movement of the user U.

The information processing system 1 includes, for example, an electronic device 10, and an information processing apparatus 20, and a mobile terminal 30 as illustrated in FIG. 1. Further, in the information processing system 1, some or all of the electronic device 10, the information processing apparatus 20, and the mobile terminal 30 may be configured to be integrated. In addition, the information processing system 1 may be configured not to include the mobile terminal 30.

The electronic device 10 is provided to move along with a foot of the user U. As an example, a case in which the electronic device 10 is attached to a shoe that the user U is wearing when the information processing system 1 is used will be described below. Further, the electronic device 10 may be attached to a foot of the user U by using a mounting tool such as a belt. In this case, the electronic device 10 is attached to, for example, an ankle of the user U.

The electronic device 10 includes a left-foot electronic device 10L attached to the shoe that the user U wears on his or her left foot, and a right-foot electronic device 10R attached to the shoe that the user U wears on his or her right foot. For the sake of convenience of explanation, the shoes that the user U wears when using the information processing system 1 will be referred to as “first shoes S” below. In addition, hereinafter, for the sake of convenience of explanation, the shoe that the user U wears on his or her left foot will be referred to as a “left foot shoe SL”, and the shoe that the user U wears on his or her right foot will be referred to as a “right foot shoe SR”. Here, the first shoes S may be shoes used for sports such as running shoes, and may be leather shoes, or other types of shoes.

Also, the electronic device 10 may be separate from the first shoes S, or may be integrated with the first shoes S. When the first shoes S are integrated, the left-foot electronic device 10L is integrated with the left foot shoe SL. In addition, in this case, the right-foot electronic device 10R is integrated with the right foot shoe SR. In the following, a case in which the electronic device 10 is separate bodies from the first shoes S will be described as an example. In this case, the left-foot electronic device 10L is attached to the left foot shoe SL at the outer side of the left foot shoe SL. In addition, in this case, the right-foot electronic device 10R is attached to the right foot shoe SR at the outer side of the right foot shoe SR. These attachments may be achieved in a method using a restraint such as a belt, or may be achieved in any other method using other instruments, jigs, equipment, and the like.

The left-foot electronic device 10L acquires one or more pieces of data indicating the way of movement of the left-foot electronic device 10L. In the following, as an example, a case in which the left-foot electronic device 10L acquires three kinds of data including acceleration data indicating acceleration of the left-foot electronic device 10L, angular velocity data indicating an angular velocity of the left-foot electronic device 10L, and position data indicating a position of the left-foot electronic device 10L will be described. In this case, the left-foot electronic device 10L includes an acceleration sensor that detects acceleration, an angular velocity sensor that detects an angular velocity, and a position data receiver that receives position data indicating a position. Here, the angular velocity sensor is a sensor capable of detecting an angular velocity of a gyro sensor, for example. In addition, the position data receiver is a receiving apparatus that receives data indicating the position measured by a Global Navigation Satellite System (GNSS) as position data indicating a position of the left-foot electronic device 10L, and is, for example, a Global Positioning System (GPS) receiver. Thus, the position data received by the position data receiver includes speed data indicating a speed of the left-foot electronic device 10L and date-and-time data indicating the date and time on which the position indicated by the position data is measured.

The left-foot electronic device 10L acquires acceleration data indicating acceleration detected by the acceleration sensor from the acceleration sensor as acceleration data indicating the acceleration of the left foot of the user U. In addition, the left-foot electronic device 10L acquires angular velocity data indicating an angular velocity detected by the angular velocity sensor from the angular velocity sensor as angular velocity data indicating the angular velocity of the left foot of the user U. In addition, the left-foot electronic device 10L acquires position data received by the position data receiver from the position data receiver as position data indicating the position of the left foot of the user U. Further, the left-foot electronic device 10L may acquire one or more pieces of other data indicating the way of movement of the left-foot electronic device 10L instead of either or both of the acceleration data and position data, or in addition to all of the acceleration data, angular velocity data, and position data. In this case, the left-foot electronic device 10L includes one or more sensors that detect each of one or more pieces of the other data. Furthermore, the left-foot electronic device 10L may acquire the angular velocity data but not acquire both the acceleration data and position data, or acquire one of the acceleration data or position data together with the angular velocity data. Here, the left-foot electronic device 10L may have a configuration without an acceleration sensor when acceleration data is not acquired. In addition, the left-foot electronic device 10L may have a configuration without a position data receiver when position data is not acquired. Hereinafter, for the sake of convenience of explanation, acceleration data, angular velocity data, and position data will be collectively referred to as detection data as long as there is no need to distinguish those kinds of data. In addition, hereinafter, for the sake of convenience of explanation, the acceleration sensor, the angular velocity sensor, and the position data receiver will be collectively referred to as detection sensors as long as there is no need to distinguish them from each other. In addition, in the following, a case in which the left-foot electronic device 10L includes one detection sensor will be described as an example. Further, the left-foot electronic device 10L may include two or more detection sensors.

In addition, the left-foot electronic device 10L acquires detection data each time a predetermined sampling period elapses. Although the predetermined sampling period is, for example, a few milliseconds, it is not limited thereto. The left-foot electronic device 10L transmits the acquired detection data to the information processing apparatus 20 via the mobile terminal 30 each time detection data is acquired.

The left-foot electronic device 10L transmits and/or receives various kinds of data to and from the mobile terminal 30 in wireless communication based on a predetermined first standard. The first standard may be, for example, the standard of Bluetooth (trade name), the standard of Wi-Fi (trade name), or another standard for wireless communication.

The right-foot electronic device 10R may have a similar configuration to that of the left-foot electronic device 10L, and may have a different configuration from that as long as the functions of the information processing system 1 described in this embodiment are not impaired. A case in which the right-foot electronic device 10R has a similar configuration to that of the left-foot electronic device 10L will be described below as an example. In this case, the right-foot electronic device 10R acquires detection data about the right foot of the user U by using a detection sensor each time the predetermined sampling period elapses. In addition, the right-foot electronic device 10R transmits the acquired detection data to the information processing apparatus 20 via the mobile terminal 30 each time detection data is acquired.

Each of the left-foot electronic device 10L and the right-foot electronic device 10R may be controlled by one processor mounted on either of the left-foot electronic device 10L and the right-foot electronic device 10R, or may be controlled by processors installed independently of each other. In the following, a case in which the left-foot electronic device 10L and the right-foot electronic device 10R are controlled by processors installed independently of each other will be described as an example. Furthermore, timings at which the left-foot electronic device 10L and the right-foot electronic device 10R acquire and transmit detection data may or may not be synchronized with each other. In the following, a case in which timings at which the left-foot electronic device 10L and the right-foot electronic device 10R acquire and transmit detection data are synchronized with each other will be described as an example. A method for achieving the configuration may be a known method, or may be a method to be developed in the future.

As described above, in this embodiment, the left-foot electronic device 10L and the right-foot electronic device 10R have the same configuration. For this reason, for the sake of convenience of description, the configurations of the left-foot electronic device 10L and the right-foot electronic device 10R will be collectively described as a configuration of an electronic device 10 below as long as the configurations need not be distinguished from each other. Furthermore, for the sake of convenience of description, the operations and processing of the left-foot electronic device 10L and the right-foot electronic device 10R will be collectively described as an operation and processing of the electronic device 10 below as long as the operations and processing need not be distinguished from each other. Thus, in the following, detection data acquired by the electronic device 10 means the two kinds of detection data including detection data acquired by the left-foot electronic device 10L and detection data acquired by the right-foot electronic device 10R.

Further, the information processing system 1 may have a configuration in which either of the left-foot electronic device 10L and the right-foot electronic device 10R is included as the electronic device 10. In this case, the information processing system 1 uses, for example, either of detection data for the left foot of the user U and detection data for the right foot of the user U as detection data for both feet of the user U. In addition, in this case, the information processing system 1, for example, attaches the electronic device 10 to the left foot shoe SL when detection data for the left foot of the user U is to be acquired, and attaches the electronic device 10 to the right foot shoe SR when detection data for the right foot of the user U is to be acquired.

The information processing apparatus 20 may be any information processing apparatus as long as the information processing apparatus can function as a server. Although the information processing apparatus 20 is, for example, a desktop personal computer (PC) or a workstation, it is not limited thereto.

The information processing apparatus 20 receives the detection data acquired by the electronic device 10 from the electronic device 10 via the mobile terminal 30 each time the electronic device 10 acquires the detection data in the measurement period described above. More specifically, the measurement period is a period in which the information processing system 1 acquires detection data using the electronic device 10, and is, for example, a period from the timing at which the information processing apparatus 20 receives, from the user, an operation to start acquisition of detection data via the mobile terminal 30 to the timing at which the information processing apparatus 20 receives, from the user, an operation to end the acquisition of the detection data via the mobile terminal 30. Each time the information processing apparatus 20 receives the detection data, the information processing apparatus 20 stores the received detection data.

Hereinafter, the average of the angular velocity indicated by the angular velocity data acquired from the left-foot electronic device 10L at a certain time and the angular velocity indicated by the angular velocity data acquired from the right-foot electronic device 10R at that time will be referred to as an average angular velocity at that time for the sake of convenience of description. In addition, hereinafter, the average of the acceleration indicated by the acceleration data acquired from the left-foot electronic device 10L at a certain time and the acceleration indicated by the acceleration data acquired from the right-foot electronic device 10R at that time will be referred to as average acceleration at that time for the sake of convenience of description. In addition, hereinafter, the average of the position indicated by the position data acquired from the left-foot electronic device 10L at a certain time and the position indicated by the position data acquired from the right-foot electronic device 10R at that time will be referred to as an average position at that time for the sake of convenience of description.

After receiving the detection data from the electronic device 10 within the measurement period, the information processing apparatus 20 generates average angular velocity data indicating the average angular velocity for each time within the measurement period, average acceleration data indicating the average acceleration for each time within the measurement period, and average position data indicating the average position for each time within the measurement period, based on all the detection data stored within the measurement period.

Thereafter, for example, the information processing apparatus 20 specifies each of a first time in which the user U moves on a flat road surface in the measurement period, a second time in which the user U moves on a sloping road surface in the measurement period, and a third time in which the user U moves on a stepped road surface in the measurement period based on the generated average angular velocity data. Then, the information processing apparatus 20 generates flat road surface information associated with first-time information indicating the first time. Here, the flat road surface information is information indicating a flat road surface. The flat road surface refers to a flat road surface that does not have a step and is not or not substantially sloping. Further, the information processing apparatus 20 generates sloping road surface information associated with second-time information indicating the second time. Here, the sloping road surface information is information indicating a sloping road surface. The sloping road surface refers to a sloping and flat road surface having no step. Furthermore, the information processing apparatus 20 generates stepped road surface information associated with third-time information indicating the third time. Here, the stepped road surface information is information indicating a stepped road surface. The stepped road surface is a road surface with a step such as stairs. Further, a method of specifying the first to third times based on the average angular velocity data may be a known method, or may be a method to be developed in the future.

Further, the information processing apparatus 20 may specify the first to third times as described above based on two pieces of data of the average angular velocity data and the average acceleration data. In this case, the information processing apparatus 20 can specify the first to third times with higher accuracy than a case in which the first to third times are calculated based on only the average angular velocity data. For example, the information processing apparatus 20 calculates the movement speed of the user U in the measurement period based on the average acceleration data and calculates the slope of the road surface on which the user U has moved in the measurement period based on the average angular velocity data. Then, the information processing apparatus 20 specifies a time in which the calculated movement speed is within a predetermined movement speed reference range and the calculated slope is within a predetermined slope reference range within the measurement period as a first time in which the user U moves on a flat road surface. Here, the movement speed reference range is a speed range including an average movement speed when the user U moves on a flat road surface, and is, for example, a range of ±10% with the movement speed as the median value. The movement speed reference range may be set by the user U via the mobile terminal 30, may be estimated by the information processing apparatus 20 based on the detection data, or may be determined by using another method. The slope reference range is a range including 0° and is, for example, an angle range of ±10% with 0° as the median value. The slope reference range may be set by the user U via the mobile terminal 30 or may be determined by using another method. In addition, the information processing apparatus 20 specifies a time in which the calculated movement speed is lower than the movement speed reference range and the calculated slope is beyond the slope reference range in the measurement period as a second time in which the user U moves on a sloping road surface. In addition, the information processing apparatus 20 specifies a time in which the calculated movement speed is lower than the movement speed reference range and the calculated slope is within the slope reference range as a third time in which the user U moves on a stepped road surface. Here, a method of calculating a movement speed of the user U based on the average acceleration data may be a known method, or may be a method to be developed in the future. Here, a method of calculating the slope of a road surface on which the user U has moved based on the average angular velocity data may be a known method, or may be a method to be developed in the future.

In addition, the information processing apparatus 20 may specify the first to third times by inertial navigation based on the average acceleration data and the average angular velocity data. Thus, the information processing apparatus 20 can specify the first to third times with even higher accuracy. Since inertial navigation is known, a detailed description thereof will be omitted.

After the three types of information including the flat road surface information, the sloping road surface information, and the stepped road surface information are generated, the information processing apparatus 20 generates information including the generated three types of information as the road surface type information indicating the type of the road surface on which the user U has moved. Here, in the present embodiment, the road surface type information is information indicating a burden of movement of the user U in the measurement period. This is because the burden of movement of the user U changes depending on whether the road surface on which the user U has moved is a flat road surface, a sloping road surface, or a stepped road surface. Thus, the road surface type information includes each piece of the flat road surface information indicating a flat road surface, the sloping road surface information indicating a sloping road surface, and the stepped road surface information indicating a stepped road surface. Further, when the first time is 0, the road surface type information may include no flat road surface information. In addition, when the second time is 0, the road surface type information may include no sloping road surface information. In addition, when the third time is 0, the road surface type information may include no stepped road surface information.

After the road surface type information is generated, the information processing apparatus 20 generates evaluation information indicating an evaluation of the user U on a predetermined action based on the generated road surface type information. When the predetermined action is delivery work or the like, the evaluation information is, for example, information including reward information indicating a reward to be paid to the user U who has performed the predetermined action. Here, the reward information may be information indicating the amount of money to be paid to the user U as the reward, information indicating an article to be paid to the user U as the reward, or information indicating another thing to be paid to the user U as the reward. In addition, when the predetermined action is exercise, the evaluation information is, for example, assessment information indicating assessment on the premium of the health insurance of the user U who has performed the predetermined action. As described above, the evaluation indicated by the evaluation information generated by the information processing apparatus 20 is a type of evaluation determined according to a predetermined action.

After the evaluation information is generated, the information processing apparatus 20 outputs the generated evaluation information. More specifically, the information processing apparatus 20 outputs the generated evaluation information to the mobile terminal 30, for example. Thus, the information processing apparatus 20 can provide the evaluation information to the user U via the mobile terminal 30. That is, the information processing apparatus 20 can provide the user U with the evaluation appropriate for the burden of the movement of the user U indicated by the road surface type information. Further, the information processing apparatus 20 may output the generated evaluation information to another information processing apparatus. The another information processing apparatus is, for example, of the company for which the user U works, a staffing agency from which the user U is dispatched, or an insurance company that provides insurance covering the user U, but is not limited thereto.

The mobile terminal 30 transmits various requests to the information processing apparatus 20, and receives various types of data from the information processing apparatus 20 as responses to the requests. In addition, the mobile terminal 30 transmits various requests to the electronic device 10 to control the electronic device 10. Furthermore, upon receiving detection data from the electronic device 10, the mobile terminal 30 transmits the received detection data to the information processing apparatus 20. In other words, the mobile terminal 30 relays transmission and reception of detection data between the electronic device 10 and the information processing apparatus 20.

The mobile terminal 30 is an information processing terminal that can be carried by the user U in this example, and is a tablet PC, a personal digital assistant (PDA), a multi-function mobile telephone terminal (smartphone), a smart watch, or a head-mounted display, for example, but it is not limited thereto. Further, the mobile terminal 30 may be a portable information processing terminal that the user U lends from another person, or may be another information processing terminal.

The mobile terminal 30 performs transmission and/or reception of various kinds of data with respect to the information processing apparatus 20 in wireless communication based on a predetermined second standard. The second standard may be, for example, the standard for Long Term Evolution (LTE) or the like, the standard for Wi-Fi (trade name) or the like, or another standard for wireless communication.

Hardware Configuration of Electronic Device

A hardware configuration of the electronic device 10 will be described below with reference to FIG. 2. FIG. 2 is a diagram illustrating an example of a hardware configuration of the electronic device 10.

The electronic device 10 includes, for example, a first processor 11, a first storage unit 12, a first communication unit 13, and a detection unit 14. These constituent components are communicatively coupled to each other via a bus. The electronic device 10 also communicates with the mobile terminal 30 via the first communication unit 13.

The first processor 11 is, for example, a central processing unit (CPU). Further, the first processor 11 may be another processor such as a field programmable gate array (FPGA), instead of a CPU. The first processor 11 executes various programs stored in the first storage unit 12.

The first storage unit 12 is a storage apparatus including, for example, a solid-state drive (SSD), an electronically erasable programmable read only memory (EEPROM), a read only memory (ROM), or a random-access memory (RAM). Further, the first storage unit 12 may be an externally mounted storage apparatus coupled by a digital input/output port such as a Universal Serial Bus (USB) or the like instead of those built into the electronic device 10. The first storage unit 12 stores various kinds of information to be processed by the electronic device 10 and various programs.

The first communication unit 13 is, for example, a communication apparatus including an antenna for wireless communication.

The detection unit 14 includes a first detector 141, a second detector 142, and a third detector 143.

The first detector 141 is an acceleration sensor that detects acceleration.

The second detector 142 is an angular velocity sensor that detects an angular velocity. In the following, a case in which the second detector 142 is a gyro sensor will be described as an example. Further, the second detector 142 may be another sensor that detects an angular velocity, instead of a gyro sensor.

The third detector 143 is a position data receiver that receives position data indicating a position. In the following, a case in which the third detector 143 is a GPS receiver will be described as an example. Further, the third detector 143 may be another receiver capable of receiving data indicating a position measured by a GNSS, instead of the GPS receiver, as position data.

Hardware Configuration of Information Processing Apparatus

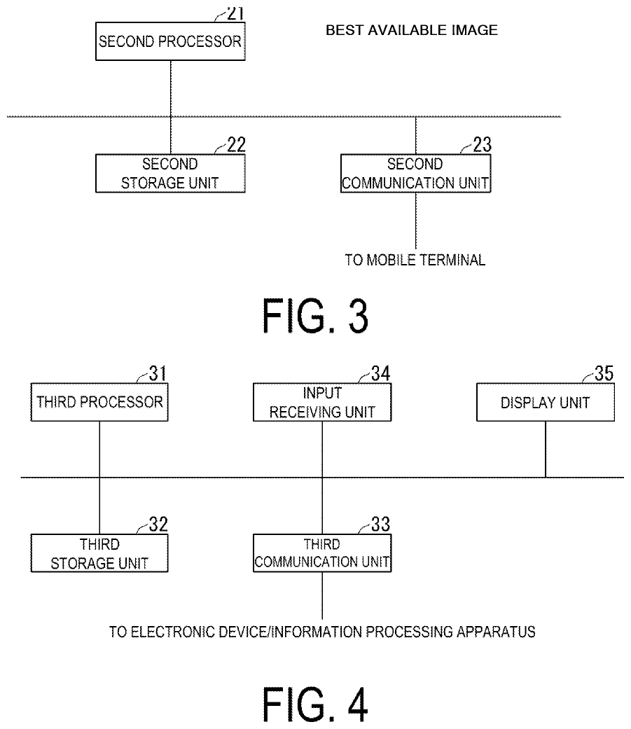

Next, a hardware configuration of the information processing apparatus 20 will be described with reference to FIG. 3. FIG. 3 is a diagram illustrating an example of a hardware configuration of the information processing apparatus 20.

The information processing apparatus 20 includes, for example, a second processor 21, a second storage unit 22, and a second communication unit 23. These constituent components are communicatively coupled to each other via a bus. The information processing apparatus 20 also communicates with the mobile terminal 30 via the second communication unit 23.

The second processor 21 is, for example, a CPU. Further, the second processor 21 may be another processor such as an FPGA, instead of a CPU. The second processor 21 executes various programs stored in the second storage unit 22.

The second storage unit 22 is a storage apparatus including, for example, a hard disk drive (HDD), an SSD, an EEPROM, a ROM, or a RAM. Further, the second storage unit 22 may be an externally mounted storage apparatus coupled by a digital input/output port such as a USB, instead of those built into the information processing apparatus 20. The second storage unit 22 stores various kinds of information, various images, and various programs to be processed by the information processing apparatus 20. For example, the second storage unit 22 stores the aforementioned determination criterion information.

The second communication unit 23 is, for example, a communication apparatus including an antenna for wireless communication.

Hardware Configuration of Mobile Terminal

A hardware configuration of the mobile terminal 30 will be described below with reference to FIG. 4. FIG. 4 is a diagram illustrating an example of a hardware configuration of the mobile terminal 30.

The mobile terminal 30 includes, for example, a third processor 31, a third storage unit 32, a third communication unit 33, an input receiving unit 34, and a display unit 35. These constituent components are communicatively coupled to each other via a bus. The mobile terminal 30 also communicates with each of the electronic device 10 and the information processing apparatus 20 via the third communication unit 33.

The third processor 31 is, for example, a CPU. Further, the third processor 31 may be another processor such as an FPGA, instead of a CPU. The third processor 31 executes various programs stored in the third storage unit 32.

The third storage unit 32 is a storage apparatus including, for example, an SSD, an EEPROM, a ROM, or a RAM. Further, the third storage unit 32 may be an externally mounted storage apparatus coupled by a digital input/output port such as a USB, instead of those built into the mobile terminal 30. The third storage unit 32 stores various kinds of information, various images, and various programs to be processed by the mobile terminal 30.

The third communication unit 33 is, for example, a communication apparatus including an antenna for wireless communication.

The input receiving unit 34 is, for example, an input apparatus including a hard key or a touch pad. The input receiving unit 34 may be integrated with the display unit 35 as a touch panel.

The display unit 35 is, for example, a display apparatus including a display.

Functional Configuration of Electronic Device and Information Processing Apparatus

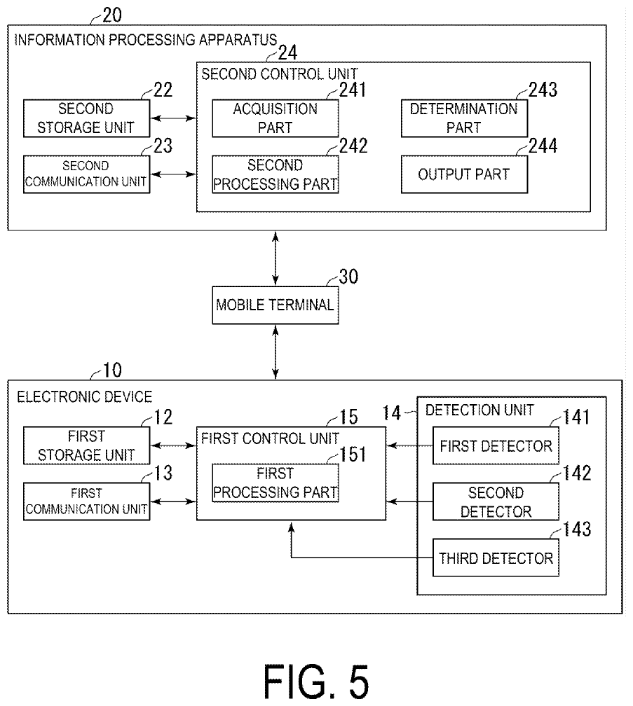

A functional configuration of each of the electronic device 10 and the information processing apparatus 20 will be described below with reference to FIG. 5. FIG. 5 is a diagram illustrating an example of a functional configuration of each of the electronic device 10 and the information processing apparatus 20.

The electronic device 10 includes, for example, the first storage unit 12, the first communication unit 13, the detection unit 14, and a first control unit 15.

The first control unit 15 controls the entire electronic device 10. The first control unit 15 includes, for example, a first processing part 151. Such a functional part included in the first control unit 15 is achieved, for example, by the first processor 11 executing various programs stored in the first storage unit 12. In addition, some or all of the functional parts may be hardware functional parts such as large-scale integration (LSI) and an application specific integrated circuit (ASIC). Further, the first control unit 15 may include other functional parts in addition to the first processing part 151.

The first processing part 151 performs various processing operations in accordance with requests received from the mobile terminal 30.

The information processing apparatus 20 includes, for example, the second storage unit 22, the second communication unit 23, and a second control unit 24.

The second control unit 24 controls the entire information processing apparatus 20. The second control unit 24 includes, for example, an acquisition part 241, a second processing part 242, a determination part 243, and an output part 244. The functional parts included in the second control unit 24 is achieved, for example, when the second processor 21 executes various programs stored in the second storage unit 22. Furthermore, some or all of the functional parts may be hardware functional parts such as an LSI or an ASIC. Further, the second control unit 24 may include other functional parts in addition to the acquisition part 241, the second processing part 242, the determination part 243, and the output part 244.

The acquisition part 241 acquires various types of data received by the information processing apparatus 20 from the electronic device 10. The acquisition part 241 acquires, for example, detection data received by the information processing apparatus 20 from the electronic device 10.

The second processing part 242 performs various processing operations according to operations received from the user U via the mobile terminal 30. For example, the second processing part 242 acquires the above-described road surface type information based on the detection data acquired by the acquisition part 241.

The determination part 243 performs various kinds of determination performed by the information processing apparatus 20.

The output part 244 outputs various kinds of information according to operations received from the user U via the mobile terminal 30. For example, the output part 244 acquires evaluation information based on the road surface type information generated by the second processing part 242 and outputs the acquired evaluation information to another apparatus such as the mobile terminal 30.

Processing of Information Processing Apparatus to Acquire Detection Data from Electronic Device

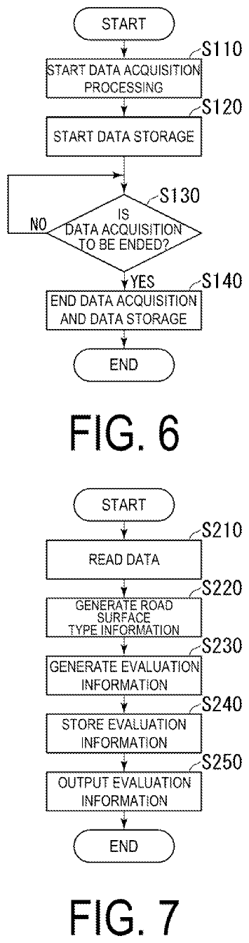

Processing of the information processing apparatus 20 to acquire detection data from the electronic device 10 will be described below with reference to FIG. 6. FIG. 6 is a flowchart illustrating an example of the flow of processing of the information processing apparatus 20 to acquire detection data from the electronic device 10. In the following, a case in which the information processing apparatus 20 receives, from the user via the mobile terminal 30, an operation of starting acquisition of detection data at a timing before the processing of step S110 illustrated in FIG. 6 is performed will be described as an example. Furthermore, in the following, a case in which the user U is wearing the left foot shoe SL with the left-foot electronic device 10L attached thereto on his or her left foot and wearing the right foot shoe SR with the right-foot electronic device 10R attached thereto on his or her right foot as illustrated in FIG. 1 at the aforementioned timing will be described as an example. Furthermore, in the following, a case in which the user U starts a predetermined action at a corresponding timing will be described as an example.

After receiving the operation of starting the acquisition of the detection data, the acquisition part 241 starts data acquisition processing via the mobile terminal 30 (step S110). Here, the data acquisition processing is processing of the acquisition part 241 to acquire the detection data from the electronic device 10 each time a predetermined sampling period elapses.

Next, the acquisition part 241 starts processing of causing the acquired detection data to be stored in the second storage unit 22 each time the detection data is acquired in the data acquisition processing started in step S110 (step S120). In FIG. 6, the processing of step S120 is indicated by “start data storage”. Further, when the detection data is to be stored in the second storage unit 22 in step S120, for example, the acquisition part 241 causes the second storage unit 22 to store date information indicating the date in association with the detection data.

Next, the acquisition part 241 waits until an operation of ending the acquisition of the detection data is received (step S130). In FIG. 6, the processing of step S130 is indicated by “end data acquisition?”

When it is determined that the operation of ending the acquisition of the detection data has been received (YES in step S130), the acquisition part 241 ends the two processing operations that are the data acquisition processing started in step S110 and the processing started in step S120 (step S140), and ends the processing of the flowchart illustrated in FIG. 6. In FIG. 6, the processing of step S140 is indicated by “end data acquisition and data storage”. Further, for example, when the predetermined action is ended, the user U performs an operation of ending the acquisition of the detection data on the information processing apparatus 20 via the mobile terminal 30.

Processing of Information Processing Apparatus to Output Evaluation Information Indicating Evaluation of User

Processing of the information processing apparatus 20 to output evaluation information indicating an evaluation of the user U will be described below with reference to FIG. 7. FIG. 7 is a flowchart illustrating an example of the flow of processing of the information processing apparatus 20 to output evaluation information indicating an evaluation of the user U.

Hereinafter, as an example, a case in which the detection data is acquired in the processing of the flowchart illustrated in FIG. 6 at a timing before the processing of step S210 illustrated in FIG. 7 is performed will be described. In other words, in the following, a case in which detection data is already stored in the second storage unit 22 in the measurement period at that timing will be described as an example. In addition, hereinafter, as an example, a case in which the processing of step S210 illustrated in FIG. 7 is started after the processing of the flowchart illustrated in FIG. 6 is performed will be described.

After the processing of the flowchart illustrated in FIG. 6 is performed, the second processing part 242 reads all of the detection date stored in the second storage unit 22 in the processing of the flowchart illustrated in FIG. 6 from the second storage unit 22 (step S210). Further, the second processing part 242 may start the processing of step S210 when the information processing apparatus 20 receives a predetermined operation via the mobile terminal 30 after the processing of the flowchart illustrated in FIG. 6 is performed. In this case, in step S210, for example, the second processing part 242 reads all of the detection information associated with the date information received from the user via the mobile terminal 30 from the second storage unit 22.

Next, the second processing part 242 generates road surface type information based on all of the detection information read in step S210 (step S220). More specifically, the second processing part 242 generates the above-described average angular velocity data based on all of the detection data. The second processing part 242 specifies the first to third times described above based on the generated average angular velocity data. Then, the second processing part 242 generates road surface type information based on the specified first to third times.

Next, the second processing part 242 generates evaluation information indicating an evaluation of the user U for a predetermined action based on the road surface type information generated in step S220 (step S230). Here, the processing of step S230 will be described.

The second processing part 242 generates evaluation information indicating an evaluation of the user U for a predetermined action based on time information associated with each type of the flat road surface information, the slopping road surface information, and the stepped road surface information included in the road surface type information generated in step S220. Specifically, for example, the second processing part 242 calculates the product of the first time indicated by first-time information associated with the flat road surface information and a first evaluation value serving as a reference as an evaluation value per unit time as a first value, calculates the product of the second time indicated by second-time information associated with the sloping road surface information and a second evaluation value higher than the first evaluation value as the evaluation value per unit time as a second value, and calculates the product of the third time indicated by third-time information associated with the stepped road surface information and a third evaluation value higher than the second evaluation value as the evaluation value per unit time as a third value. The second processing part 242 generates information indicating the sum of the calculated first value to third value as reward information indicating a reward to be paid to the user U for the predetermined action. Then, the second processing part 242 generates information including the generated reward information as evaluation information. Here, the first evaluation value to the third evaluation value are the amount of remuneration per unit time, that is, an hourly wage. Accordingly, the information processing apparatus 20 can generate evaluation information indicating the burden of the movement of the user U in the measurement period, that is, evaluation that is appropriate for the burden of the predetermined action. Further, the reason for a second evaluation value being higher than a first evaluation value is that the burden of movement of the user U on a sloping road surface is greater than the burden of movement of the user U moving on a flat road surface. In other words, this is because walking on a sloping road surface is more tiring than walking on a flat road surface. Further, the reason for a third evaluation value being higher than a second evaluation value is that the burden of movement of the user U on a stepped road surface is greater than the burden of movement of the user U on a sloping road surface. In other words, this is because walking on a stepped road surface is more tiring than walking on a sloping road surface. Here, each of the first evaluation value to the third evaluation value is input to the information processing apparatus 20 by an evaluator who evaluates the user U, for example. Further, each of the first evaluation value to the third evaluation value may be input to the information processing apparatus 20 by any method. In addition, the relative level of the first to third evaluation values may be different from each other depending on the content of the predetermined action. For example, when the predetermined action is transportation of a package for which walking on a flat road surface is more tiring than walking on a sloping road surface, the second evaluation value may be lower than the first evaluation value. In addition, the first evaluation value to the third evaluation value may be other types of values such as points per unit time, instead of an hourly wage.

Here, for example, when the first time and the third time are not zero but the second time is zero, the above-described second value is zero. This means that the user U has been moving on a road surface on which a flat road surface is mixed with a stepped road surface in the measurement period. In addition, in that case, the second processing part 242 calculates the product of the first time and the first evaluation value as a first value, calculates the product of the third time and the third evaluation value as a third value, and generates information indicating the sum of the calculated first value and third value as reward information.

Furthermore, for example, when the first time and the second time are not zero and the third time is zero, the third value is zero. This means that the user U has been moving on a road surface on which a flat road surface is mixed with a stepped road surface in the measurement period. In addition, in that case, the second processing part 242 calculates the product of the first time and the first evaluation value as a first value, calculates the product of the second time and the second evaluation value as a second value, and generates information indicating the sum of the calculated first value and second value as reward information.

Furthermore, for example, when the first time is not zero and the second and third times are zero, the second and third values are zero. This means that the user U has been moving on a road surface on in the measurement period. Thus, in this case, the second processing part 242 generates information indicating the product of the first time and the first evaluation value as reward information.

In this way, the information processing apparatus 20 can represent the burden of movement of the user U based on the road surface type information generated in step S220, generate the reward information based on the road surface type information, and generate evaluation information based on the generated reward information.

After the processing of step S230 is performed, the second processing part 242 stores the evaluation information generated in step S230 in the second storage unit 22 (step S240). At this time, the second processing part 242 stores, for example, the evaluation information in which user identification information for identifying the user U is associated with date information indicating the date in the second storage unit 22. Accordingly, for example, an evaluator who evaluates the user U can read the evaluation information of the user U for a desired date later by operating the information processing apparatus 20 via the information processing apparatus operated by the evaluator.

Next, the second processing part 242 outputs the evaluation information generated in step S230 to another information processing apparatus such as the mobile terminal 30 (step S250), and ends the processing of the flowchart illustrated in FIG. 7.

As described above, the information processing apparatus 20 generates the road surface type information indicating the type of the road surface on which the user U has moved based on the detection data detected by the electronic device 10 provided to move together with the foot of the user U, and outputs the evaluation information indicating an evaluation of the user U based on the generated road surface type information. Thus, the information processing apparatus 20 can provide the user U with evaluation appropriate for the burden of movement of the user U.

Further, the information processing apparatus 20 described above may generate movement speed information indicating a movement speed of the user U at each time in the measurement period based on generated average acceleration data in step S220. In this case, for example, the information processing apparatus 20 specifies a fourth time in which the user U is moving at a movement speed equal to or higher than a predetermined threshold in the measurement period in step S230. The predetermined threshold is a value exceeding the limit of speed that the user U can achieve by bipedal locomotion, and is, for example, 20 km/h. This is a value determined based on the fact that the average running speed of an adult is about 16 km/h. That is, the fourth time is a time in which the user U moves by using a mobility object in the measurement period. The mobility object is a bicycle, a motorcycle, a four wheeled vehicle, a train, or the like, but it is not limited thereto. When the fourth time is not zero, the information processing apparatus 20 generates, as the reward information, information indicating the value obtained by subtracting the product of a fourth evaluation value serving as a reference that is a value for decreasing the sum of the above-described first to third values and the fourth time from the sum. This is because the burden of movement of the user U when he or she uses a mobility object is reduced. As a result, the information processing apparatus 20 can perform evaluation appropriate for the burden of movement of the user U with higher accuracy. However, when a use of a mobility object for movement of the user U is expected to improve evaluation, the information processing apparatus 20 may generate, as reward information, information indicating a value obtained by adding the product of a fifth evaluation value serving as a reference that is a value for increasing the sum of the first to third values and the fourth time to the sum.

In addition, when the first value is to be calculated, the information processing apparatus 20 described above may calculate, as the first value, the product of a first distance in which the user U has moved within the first time and a sixth evaluation value serving as a reference that is an evaluation value per unit distance. In addition, when the second value is to be calculated, the information processing apparatus 20 may calculate, as the second value, the product of a second distance in which the user U has moved within the second time and a seventh evaluation value that is higher than the sixth evaluation value serving as an evaluation value per unit distance. In addition, when the third value is to be calculated, the information processing apparatus 20 may calculate, as the third value, the product of a third distance in which the user U has moved within the third time and an eighth evaluation value that is higher than the seventh evaluation value serving as an evaluation value per unit distance. Thus, the information processing apparatus 20 can output the evaluation information indicating an evaluation according to a distance instead of a time. Further, the information processing apparatus 20 may calculate the first distance to the third distance based on the average position data, based on the average acceleration data, or by using another method.

In addition, the reward information described above may be, for example, assessment value information indicating a score obtained by quantifying the assessment of the premium of the health insurance of the user U who has performed a predetermined action. In this case, each of the evaluation values such as the first evaluation value to the third evaluation value is a score, not an hourly wage. In this way, the evaluation information may include information indicating other types of values calculated in accordance with each of the first time to the third time, instead of the reward information. In addition, the evaluation information may include information indicating the values in addition to the reward information.

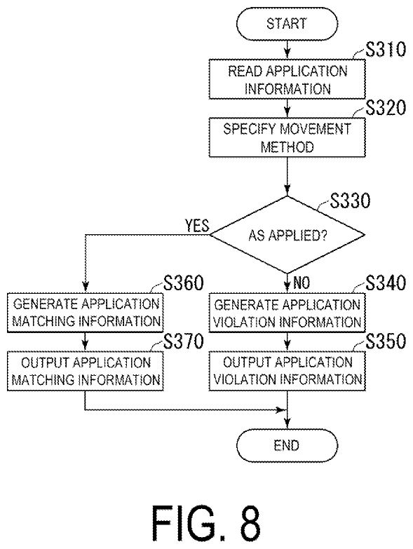

In addition, when a movement method of the user U for a predetermined action has been applied in advance, the information processing apparatus 20 described above can determine whether the movement method of the user U is different from the prior application based on the movement speed information described above. FIG. 8 is a flowchart illustrating an example of the flow of processing of the information processing apparatus 20 to determine whether a movement method of the user U is different from the prior application. Hereinafter, as an example, a case in which application information indicating a prior application for a movement method of the user U is stored in advance in the second storage unit 22 of the information processing apparatus 20 at a timing before the processing of step S310 illustrated in FIG. 8 is performed will be described. In addition, as an example, a case in which the information processing apparatus 20 receives an operation of starting the processing of determining whether the movement method of the user U is different from the prior application in advance via the mobile terminal 30 at the timing will be described below. Furthermore, a case in which the information processing apparatus 20 has already specified the fourth time in the measurement period at the timing will be described below as an example.

The second processing part 242 reads the application information stored in advance in the second storage unit 22 from the second storage unit 22 (step S310).

Next, the second processing part 242 specifies the movement method of the user U in the measurement period based on whether the fourth time specified in advance is zero (step S320). To be specific, in step S320, when the fourth time is zero, for example, the second processing part 242 determines that the movement method of the user U is movement by bipedal locomotion, and in contrast, when the fourth time is not zero in step S320, for example, the second processing part 242 determines that the movement method of the user U is a method using a mobility object.

Next, the determination part 243 determines whether the movement method of the user U indicated by the application information read in step S310 matches the movement method of the user U specified in step S320 (step S330). In FIG. 8, the processing of step S330 is indicated by “as applied?”

When it is determined that the movement method of the user U indicated by the application information read in step S310 matches the movement method of the user U specified in step S320 (YES in step S330), the second processing part 242 generates application matching information indicating that the movement method of the user U indicated by the application information read in step S310 matches the movement method of the user U specified in step S320 (step S360).

Next, the second processing part 242 outputs the application matching information generated in step S360 to another information processing apparatus such as the mobile terminal 30 (step S370), and ends the processing of the flowchart illustrated in FIG. 8.

On the other hand, when it is determined that the movement method of the user U indicated by the application information read in step S310 does not match the movement method of the user U specified in step S320 (NO in step S330), the second processing part 242 generates application violation information indicating that the movement method of the user U indicated by the application information read in step S310 does not match the movement method of the user U specified in step S320 (step S340).

Next, the second processing part 242 outputs the application violation information generated in step S340 to another information processing apparatus such as the mobile terminal 30 (step S350), and ends the processing of the flowchart illustrated in FIG. 8.

When a movement method of the user U for a predetermined action has been applied in advance as described above, the information processing apparatus 20 can determine whether the movement method of the user U is different from the prior application based on the movement speed information described above. As a result, the information processing apparatus 20 can prevent the user U from violating the rule, for example.

In addition, the generation and output of evaluation information by the information processing apparatus 20 as described above may be applied to, for example, generation and output of evaluation information including reward information indicating a reward for physical labor at a construction site, generation and output of evaluation information including reward information indicating a reward for labor in each area such as an assembly area and a baggage handling area in a factory, generation and output of insurance assessment for exercise for health, or generation and output of other types of evaluation information.

Furthermore, in the information processing system 1 described above, all of the matters described above may be combined in any manner.

As described above, an information processing apparatus according to an embodiment generates road surface type information indicating the type of road surface on which a user has moved based on data detected by the electronic device provided to move together with a foot of the user, and outputs evaluation information indicating an evaluation of the user based on the generated road surface type information. Here, in the example described above, the information processing apparatus 20 is an example of the aforementioned information processing apparatus. In addition, in the example described above, the user U is an example of the aforementioned user. In addition, in the example described above, the electronic device 10 is an example of the aforementioned electronic device.

In addition, with respect to the information processing apparatus, the electronic device may include an angular velocity sensor that detects an angular velocity, data may include angular velocity data indicating an angular velocity detected as an angular velocity of a foot of the user by the angular velocity sensor, and the information processing apparatus may generate road surface type information based on the angular velocity data included in the data.

In addition, with respect to the information processing apparatus, the electronic device may include an acceleration sensor that detects acceleration, data may include acceleration data indicating acceleration detected as acceleration of a foot of the user by the acceleration sensor, and the information processing apparatus may generate road surface type information based on the angular velocity data included in the data and the acceleration data included in the data.

In addition, the information processing apparatus may employ a configuration in which, when first data is acquired as data, first road surface type information based on the first data is generated as road surface type information and first evaluation information is output as evaluation information based on the generated first road surface information, and when second data different from the first data is acquired as the data, second road surface type information based on the second data is generated as the road surface type information, and second evaluation information different from the first evaluation information is output as the evaluation information based on the generated second road surface type information.

Furthermore, the information processing apparatus may employ a configuration in which the evaluation information includes reward information indicating a reward to be paid to the user.

In addition, the information processing apparatus may employ a configuration in which the road surface type information includes at least one of flat road surface information indicating a flat road surface, sloping road surface information indicating a sloping road surface, or stepped road surface information indicating a road surface having a step.

In addition, the information processing apparatus may employ a configuration in which movement speed information indicating a movement speed of the user is further generated based on the data, and the evaluation information is output based on the generated road surface type information and the generated movement speed information.

Although the embodiments of this disclosure have been described in detail with reference to the drawings, the specific configurations are not limited to these embodiments, and may be modified, substituted, deleted, and the like without departing from the spirit of this disclosure.

In addition, a program for achieving the functions of any constituent units of the apparatus described above may be recorded in a computer-readable recording medium, and the program may be read and executed by a computer system. Here, the apparatus is, for example, the electronic device 10, the information processing apparatus 20, or the mobile terminal 30. Further, the “computer system” mentioned here is assumed to include hardware such as an operating system (OS) or a peripheral apparatus. Furthermore, the “computer-readable recording medium” refers to a portable medium such as a flexible disk, a magneto-optical disk, a ROM, and a compact disc (CD)-ROM, and a storage apparatus such as a hard disk built into a computer system. Furthermore, the “computer-readable recording medium” is assumed to include one that holds a program for a certain period of time, such as volatile memory inside a computer system serving as a server or a client when a program is transmitted via a network such as the Internet or a communication line such as a telephone line.

In addition, the program described above may be transmitted from a computer system storing the program in a storage apparatus or the like to another computer system via a transmission medium or using transmission waves in a transmission medium. Here, the “transmission medium” for transmitting a program refers to a medium having a function of transmitting information, like a network such as the Internet or a communication line such as a telephone line.

In addition, the program described above may be one to achieve some of the functions described above. Furthermore, the program described above can be a so-called differential file or a differential program that can achieve the above-described functions in combination with a program already recorded in the computer system.

What is claimed is:

1. An information processing apparatus configured to:
generate road surface type information based on data detected by an electronic device provided to move together with a foot of a user, the road surface type information indicating a type of road surface on which the user moved, and
output evaluation information based on the generated road surface type information, the evaluation information indicating an evaluation of the user.

2. The information processing apparatus according to claim 1, wherein
the electronic device includes an angular velocity sensor configured to detect an angular velocity,
the data includes angular velocity data indicating the angular velocity detected as an angular velocity of the foot of the user by the angular velocity sensor, and
the information processing apparatus generates the road surface type information based on the angular velocity data included in the data.

3. The information processing apparatus according to claim 2, wherein
the electronic device includes an acceleration sensor configured to detect acceleration,
the data includes acceleration data indicating the acceleration detected as acceleration of the foot of the user by the acceleration sensor, and
the information processing apparatus generates the road surface type information based on the angular velocity data included in the data and the acceleration data included in the data.

4. The information processing apparatus according to claim 1, wherein
when first data is acquired as the data, first road surface type information based on the first data is generated as the road surface type information, and first evaluation information is output as the evaluation information based on the generated first road surface information and
when second data different from the first data is acquired as the data, second road surface type information based on the second data is generated as the road surface type information, and second evaluation information different from the first evaluation information is output as the evaluation information based on the generated second road surface type information.

5. The information processing apparatus according to claim 1, wherein
the evaluation information includes reward information indicating a reward to be paid to the user.

6. The information processing apparatus according to claim 1, wherein
the road surface type information includes at least one of flat road surface information indicating a flat road surface, sloping road surface information indicating a sloping road surface, or stepped road surface information indicating a road surface having a step.

7. The information processing apparatus according to claim 1, wherein
movement speed information indicating a movement speed of the user is further generated based on the data and
the evaluation information is output based on the generated road surface type information and the generated movement speed information.

8. An information processing system comprising:
the information processing apparatus according to claim 1; and
the electronic device according to claim 1.

9. A non-transitory computer-readable storage medium storing a program, the program being configured to cause a computer of an information processing apparatus to:
generate road surface type information based on data detected by an electronic device provided to move together with a foot of a user, the road surface type information indicating a type of road surface on which the user moved, and
output evaluation information based on the generated road surface type information, the evaluation information indicating an evaluation of the user.
